(19) United States
(12) Patent Application Publication
(10) Pub. No.: US 2004/0258100 A1
(43) Pub. Date: Dec. 23, 2004

(54) Location service support for distributed bts architecture

(76) Inventors: Arto Jantti, Oulu (FI); Timo Nasakkala, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/487,907

(22) PCT Filed: Jun. 28, 2002
(86) PCT No.: PCT/IB02/03180

(51) Int. Cl. H04J 3/06

(52) U.S. Cl. 370/508

(57) ABSTRACT

There is disclosed, in a communication system comprising a receiver and a plurality of sub-receivers, wherein signals received at each sub-receiver are forwarded to the receiver, a method for determining at which one of the plurality of sub-receivers a signal received at the receiver is received from, comprising: allocating a time delay to each sub-receiver; delaying a signal received at each sub-receiver by the corresponding time delay; and determining the presence of a received signal in a time window associated with each time delay, wherein a signal received in a time window associated with a particular time delay is determined to have been received by the corresponding sub-receiver.

### FIELD OF THE INVENTION

The present invention relates to communication systems in which a transceiver is associated with multiple remote transceivers, for transmitting and receiving a signal associated with that transceiver. The invention is particularly but not exclusively concerned with a mobile communication system in which a donor base transceiver station is associated with a plurality of remote head units.

### BACKGROUND TO THE INVENTION

Location based services are becoming very important in relation to future mobile communication networks. As such, the need to accurately determine the locations of a mobile station is becoming increasingly important.

There are also proposals to utilize distributed WCDMA (Wideband Code Division Multiple Access) base station architectures. Such architectures utilize remote head equipment where part of a BTS (base transceiver station), for example the RF (radio frequency) section, is remotely connected to the donor BTS part with a coaxial cable, fiber link or other appropriate connection.

When using such a system with remote heads, the same carrier signal may be transmitted and received via several remote heads, as in a distributed antenna system. However, in current systems signals transmitted from such heads do not include an identification of the head: they only include an identification of the associated BTS. As such, it is not possible to determine from which head a signal has been transmitted. Whilst the physical location of the heads is known, without the knowledge of which head transmitted a particular signal standard techniques for determining the location of the mobile have reduced effectiveness or provide inaccurate results.

All current location determination methods, except network assisted GPS, assume that the location of the signal source, i.e. the base station antenna is known. In distributed systems there are several signal sources, and the originating signal source is not known.

It is desirable that location based services should be fully supported in this kind of distributed base station architecture.

It is an object of the present invention to provide a solution to one or more of the above-stated problems.

### SUMMARY OF THE INVENTION

According to the present invention there is provided, in a communication system comprising a receiver and a plurality of sub-receivers, wherein signals received at each sub-receiver are forwarded to the receiver, a method for determining at which one of the plurality of sub-receivers a signal received at the receiver is received from, comprising: allocating a time delay to each sub-receiver; delaying a signal received at each sub-receiver by the corresponding time delay; and determining the presence of a received signal in a time window associated with each time delay, wherein a signal received in a time window associated with a particular time delay is determined to have been received by the corresponding sub-receiver.

The communication system may be a cellular communication system, each sub-receiver being associated with a sub-cell of a cell associated with the receiver.

The identification of the sub-receiver at which a signal is received may identify the sub-cell area within which the signal is transmitted from.

The method may further comprise identifying the location within the sub-cell from which the signal is transmitted from.

The communication system may be an indoor radio system.

The signal may be received from a mobile station.

The receiver may be part of a base transceiver station.

In accordance with another aspect the present invention provides a receiver for receiving signals from a plurality of sub-receivers, including: means for delaying a signal from each respective sub-receiver by a respective pre-determined time delay; and means for determining the presence of a received signal in a time window associated with each respective time delay, wherein a signal received in a time window associated with a particular time delay is determined to have been received by the corresponding sub-receiver.

The means for delaying a signal from each respective sub-receiver may comprise a delay element having the predetermined delay time.

The delay element may include a filter.

The filter may be a surface acoustic wave filter.

The delay element may include an optical transmission line.

The means for determining the presence of a received signal may include a rake filter.

The receiver may be associated with a base transceiver station defining a cell of the communication system, each sub-receiver defining a sub-cell of the cell.

A signal determined to be received at a particular sub-receiver may identify the source of the signal in the respective sub-cell.

The receiver may further comprise means for identifying the location of the source of the signal in the sub-cell.

The present invention thus solves the problems identified in the background of the invention by making the remote head identification possible.

Preferably, a normal WCDMA BTS rake receiver is utilized in the identification process. Such a receiver is able to measure the delay in the received signal path. The length of the delay is different for each remote head unit. Based on this information, the donor BTS receiver unit can identify the remote head that is receiving the strongest signal from the mobile station. This information can be advantageously used to calculate a position of the mobile station.

Standard location methods may be used to calculate the position of the mobile station, for example: cell-ID; round trip time (RTT); or idle periods downlink—observer time difference of arrival (IPDL-OTDOA).

The inventive solution advantageously requires no modification to the remote head equipment.

### BRIEF DESCRIPTION OF THE DRAWINGS

The invention will now be describer by way of example with reference to the accompanying drawings, in which:

FIG. 1 illustrates an exemplary implementation of WCDMA system including a remote head unit;

FIG. 2 illustrates in block diagram form the principle of transmitting a signal from a BTS through a plurality of remote heads;

FIG. 3 illustrates the relative timing of signals received at remote heads in accordance with a preferred implementation of the present invention;

FIG. 4 illustrates the use of the relative timings of FIG. 3 in implementation a location service in accordance with a preferred embodiment of the present invention;

FIG. 5 illustrates an exemplary implementation of an indoor radio system in which the present invention may be advantageously utilized;

FIG. 6 illustrates an implementation of a cell and sub-cell location system in accordance with a preferred implementation of the present invention;

FIG. 7 illustrates the main elements of a WCDMA system for implementing a particular location technique in conjunction with a preferred implementation of the present invention; and

FIG. 8 illustrates an example of a location determination technique using a preferred embodiment of the present invention.

### DESCRIPTION OF PREFERRED EMBODIMENTS

The invention will now be described by way of reference to preferred examples. It should be noted that the invention is not limited to any example presented herein. Specific examples are presented herein for the purposes of illustrating the present invention, and conveying an understanding of the present invention.

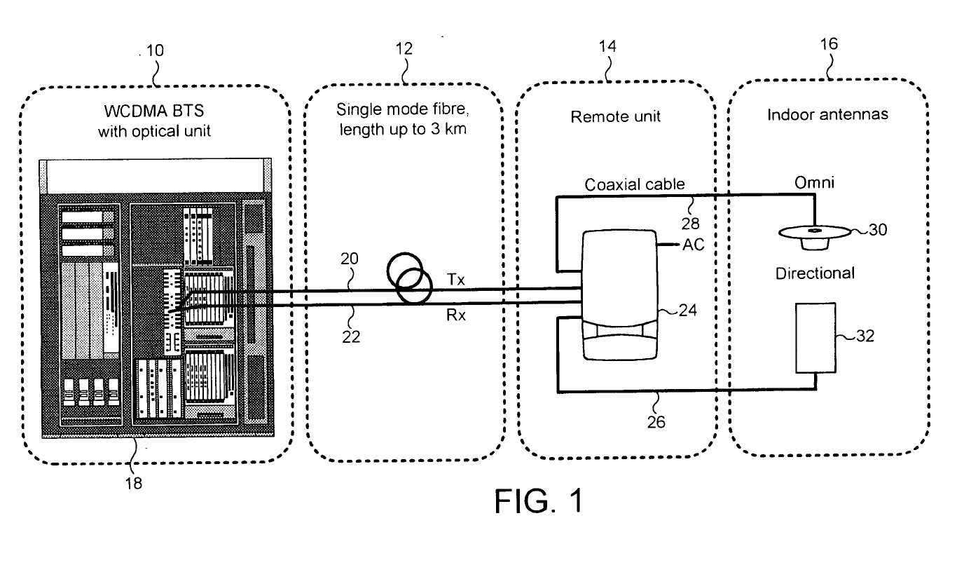

Referring to FIG. 1, there is illustrated in block diagram form a system overview of an indoor radio system in respect of which a preferred embodiment of the present invention is described.

Reference numeral 10 generally refers to a base transceiver station (BTS), in this particular example a WCDMA BTS including an optical unit, designated by reference number 18. Block 12 generally designates a transmission medium between the BTS 10 and one or more remote units. In this preferred example, a transmission medium 12 is an optical transmission medium, including an optical transmission line 20 upon which signals are transmitted from the BTS, and an optical transmission line 22 upon which signals are received and input to the BTS 10. Reference numeral 14 generally designates one of a plurality of remote head units, and reference numeral 16 generally designates an antenna associated with the remote head unit 14. In FIG. 1, a remote head unit comprises a block 24, having a coaxial cable connection 28 to an omni-directional antenna 30 and a cable 26 connecting to a directional antenna 32. The omni-directional antenna 30 and directional antenna 32 comprise the indoor antennas associated with the remote unit 24.

Although the present invention is described herein with reference to a BTS including an optical unit, the invention is not limited to such an implementation. However the use of an optical unit does convey particular advantages. An optical unit does not require a linear power amplifier (LPA) or an antenna filter (AF). The optical unit is part of the BTSs internal communication system, and with current implementations may support up to twelve remote head units. It is possible that optical sectors can be used in combination with other more conventional sectors. As such the BTS 10 of FIG. 1 may connect to certain remote head units via optical communications, and to other remote head units on a different communication medium.

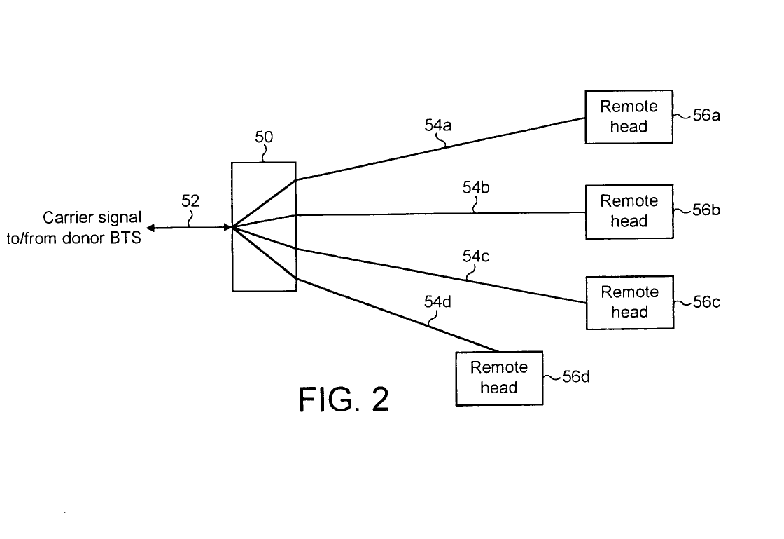

Referring to FIG. 2, there is further illustrated in block diagram form the interconnection of the BTS 10 to a plurality of remote head units 14. Referring to FIG. 2, there is illustrated a splitter/combiner 50, and four remote head units 56a-56d. The splitter/combiner 50 receives signals from the BTS on a line 52, and splits such signals so that they are transmitted to each of the remote head units 56a-56d via respective communication lines 54a-54d. Signals received at each of the remote head units are transferred to the combiner/splitter 50 via respective communication lines 54a-54d, and combined for transmission to the BTS on line 52. Although four remote head units are shown in FIG. 2, this is purely for the purposes of illustration, and any number of remote head units may be provided as supported by the system. The combiner/splitter 50 may comprise part of the BTS 10, or may be provided as a separate unit at the input/output of the BTS 10. As discussed hereinabove, in a preferable embodiment the combiner/splitter 50 is an optical combiner/splitter.

In a mobile communication system, the BTS transmits signals to any mobile station within the radio coverage area of the cells supported by the BTS. In an arrangement such as that shown in FIGS. 1 and 2, the signals associated with the BTS are transmitted to mobile stations via the remote head units 56a-56d. Similarly, the BTS receives signals from any mobile station in its radio coverage area via remote head units 56a-56d.

In accordance with the present invention, each of the remote head units 56a-56d is associated with a predetermined time delay. As such any signal received by one of the remote head units 56a-56d is received at the BTS 10 with a predetermined time delay associated therewith. The implementation of the time delay for each of the remote head units is discussed further hereinbelow.

In accordance with standard techniques, the BTS 10 is preferably provided with a rake receiver for receiving signals from any mobile station in its radio coverage area. As is well-known in the art, such a rake receiver receives various multi-path signals, and compensates for time offsets in such signals.

In accordance with the preferred implementation of the present invention, a rake receiver in the BTS 10 is used to identify any signal received at each of the remote head units 56a-56d.

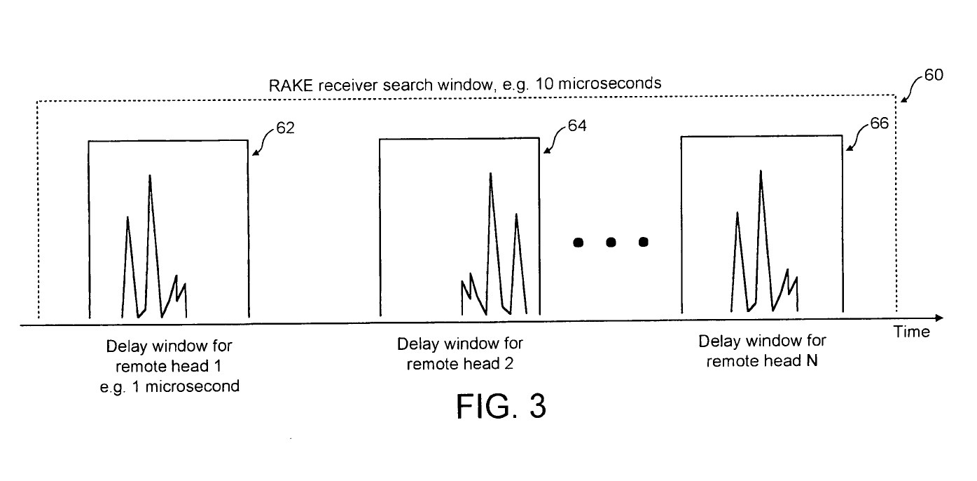

An illustration of the implementation of the rake receiver in such a manner is now described with reference to FIG. 3.

For the purposes of this example, it is assumed that the rake receiver has a search window of 10 microseconds. Each of the remote head units 56a-56d is associated with a particular time delay, which falls within the rake receiver search window. Each of the time delays may be considered to be a delay window within the rake receiver search window.

Referring to FIG. 3, a first delay window 62 may be associated with the first remote head unit, e.g. remote head unit 56a. A second delay window 64 may be associated with the second remote head unit, e.g. remote head unit 56b. A nth delay window 66 may be associated with an nth remote head unit of the system, in this example remote head unit 56d of FIG. 2. As can be understood from FIG. 3, and each of the respective delay windows 62, 64 and 66 the rake receiver looks for a received signal from the associated remote head unit. Any received signal received in that specific delay window is assumed to be from the associated remote head unit.

In this way, it is possible to identify the specific remote head unit at which a signal from the mobile station has been received.

The delay spread within a single remote head unit coverage area is small compared to the whole rake receiver search window, as can be seen from FIG. 3. As there is a different delay for each remote head unit, each remote head unit can be identified based on the specific delay which is predetermined in the BTS rake receiver. As a result, the system knows the mobile station location to be within the coverage area of the particular remote head unit. The accuracy of such determination of location is dependent upon the accuracy of the coverage area. In a typical indoor radio system, such coverage area may be 20 to 40 meters. In addition, and as discussed further hereinbelow, more accurate methods of location determination can be supported using this technique.

The introduction of the delay in the signals received at each of the remote head units can be implemented in a variety of ways. The optical/radio frequency converter associated with the BTS 10 may generate the delay artificially.

The optical connections between the splitter/combiner 50 and remote head units 56a-56d of FIG. 2 may alternatively be used to introduce a delay. Each of the optical links 54a-54d is associated with an inherent characteristic delay, and these characteristics may be used to introduce a delay in the received signals.

As discussed hereinabove, the distributed BTS architecture may be implemented with different interfaces between the BTS and the remote heads. Such interfaces may be baseband I/Q, intermediate frequency (IF) or radio frequency (RF) interface. With baseband I/Q the delay can be simply made in the digital domain. With an IF or RF interface, the delay must be implemented in the analogue domain, for example using delay filters (e.g. surface acoustic wave (SAW) filter), or in a fibre (where the fibre extends over hundreds of metres).

In terms of implementation of the rake receiver, the remote head units 56a to 56d, in an indoor radio system, are within a limited distance from the BTS, for example 3 kilometres. As such the whole width of the normal search window is not likely to be used. Because the distance between the remote heads and the BTS is known, the search window can be short.

The geographical location information of each of the remote head units 56a-56d is stored in the system during the installation phase. As discussed further hereinbelow, based on the known delay and the known remote head location information, the location of the mobile station can be estimated. The system compensates for the artificial delays introduced in order to determine the remote head unit, so that the mobile station location estimate gives accurate results.

Where the implementation of the interface between the remote head units and the BTS is an IF or an RF interface, the use of a SAW filter reduces receiver sensitivity. However this is not a degenerating factor, because the users, i.e. mobile stations, are close to the remote head units. The optical delay line may be used to implement the artificial delay only where the optical interconnection between the remote head units and the BTS is quite long, of the order of hundreds of metres or a kilometre or greater. However this does have the advantage of allowing the normal distance between the BTS and the remote head units utilized generating the artificial delay.

Implementation of the present invention as described hereinabove has the particular advantage of not requiring any modification of the remote head equipment. Changes are preferably implemented at the BTS, preferably in the optical converter box.

The information as to which remote head units receive the signal from the mobile station is preferably used, as has been discussed hereinabove, in order to determine the location of the mobile station. Standard location methods can be utilized, such as cell-ID, Round Trip Time (RTT), Idle Period Downlink-Observed Time Difference of Arrival (IPDL-OTDOA). Use of the present invention in order to calculate the position of a mobile station is discussed further hereinbelow.

A preferred embodiment of the present invention allows the remote head identification at sub-cell level. 3GPP standardized round-trip-time measurement (RTT) is utilized in an advantageous way in the preferred embodiment of the present invention. The radio access network system is able to measure the round trip time from the base station signal transmission, to the mobile station reception, to the mobile station transmission, and to the base station reception. Together with the identification of the remote head unit receiving the signal, as discussed hereinabove, this information is used to calculate the position of the mobile station.

In a practical implementation, more than one of the remote head units 56a-56d will receive a signal from the mobile station. As such, the BTS will successfully detect a received signal from more than one remote head station.

As discussed above, the present invention allows the remote head station at which a signal was received to be identified. Such receipt of a signal may occur at multiple remote head units. The further adaptation of this technique in order to provide an accurate determination of the location of the mobile station preferably uses a technique such as round trip time (RTT).

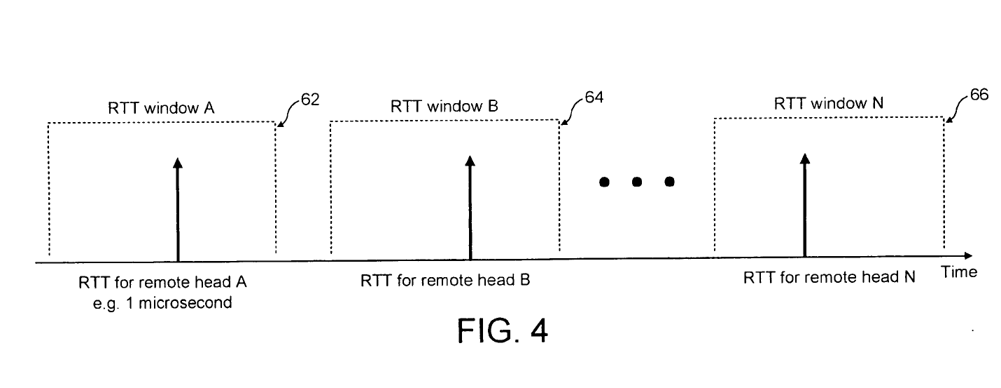

Referring to FIG. 4, each delay window 62, 64 and 66 associated with the respective remote head units can also be considered to be RTT windows. Although in this particular embodiment an RTT technique is used, location of the mobile station may be determined using various other techniques, such as cell-ID, or Idle Period Downlink-Observed Time Difference of Arrival (IPDL-OTDOA).

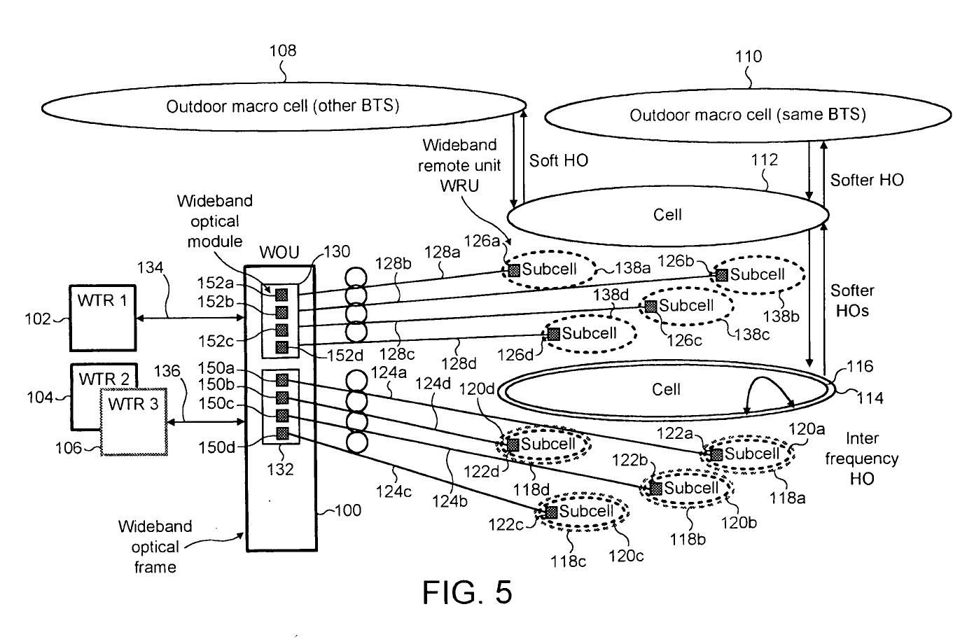

Referring to FIG. 5, there is further illustrated a system arrangement of an indoor radio system according to a preferred implementation of the present invention.

Block 100 represents a wideband optical unit (WOU) including wideband optical modules (two of which 130 and 132 are shown in FIG. 5). The wideband optical module 130 has four connections to respective remote head units 126a 126d via optical connections 128a-128d. The wideband optical module 132 has connections to respective remote head units 122a-122d via optical communication links 124a-124d. The wideband optical module 100 is associated with a BTS which supports sub-cells 138a-138d associated with remote head units 126a-126d respectively. In addition the BTS supports sub-cells 118a-118d associated with a first frequency of remote head units 122a-122d, and sub-cells 120a-120d on a second frequency of remote head units 122a-122d. The sub-cells 138a-138d together form a cell 112, sub-cells 118a-118d together form a cell 114. The sub-cells 120a-120d together form a cell 116. In addition the BTS is associated with an outdoor micro cell 110. Inter-frequency handovers take place between the respective frequencies of the cells 114 and 116. Softer handovers take place between the cell 112 and the respective cells 114, 116 and 110. Soft handovers take place between the outdoor micro cell 108 and the cells 112, 114 or 116.

As a system with WCDMA technology, the wideband optical unit 100 may comprise a wideband optical frame. Each of the remote head units 122a-122d and 126a-126d may be wideband remote units (WRU). On the BTS side of the wideband optical unit 100, there are connections 134 between the optical module 130 and a first wideband transceiver (WTR) 102. There are further provided connections between the optical module 132 and second and third WTR's 104 and 106 via links 136. WTR 102 represents the wideband transceiver part of the BTS associated with cell 112. WTR 104 represents the wideband transceiver part of the BTS associated with cell 116. WTR 106 represents the wideband transceiver part of the BTS associated with cell 114.

The wideband optical module includes four delay elements, 152a-152d, each associated with a remote head unit 126a-126d. These delay elements introduce delays into the respective received signal lines in order to identify the remote head unit at which a given signal is received. Thus received signals on optical lines 128a-128d are received in the optical module 130 at respective delay elements 152a-152d. Delay elements delay respective signals, before combining at the output of the optical module and forwarding to the BTS. The optical module 132 is similarly provided with delay elements 150a-150d. As discussed hereinabove, the optical lines themselves may in fact provide part or all of the delay, in which case the presence of the delay elements 152a-152d and 150a-150d may not be required.

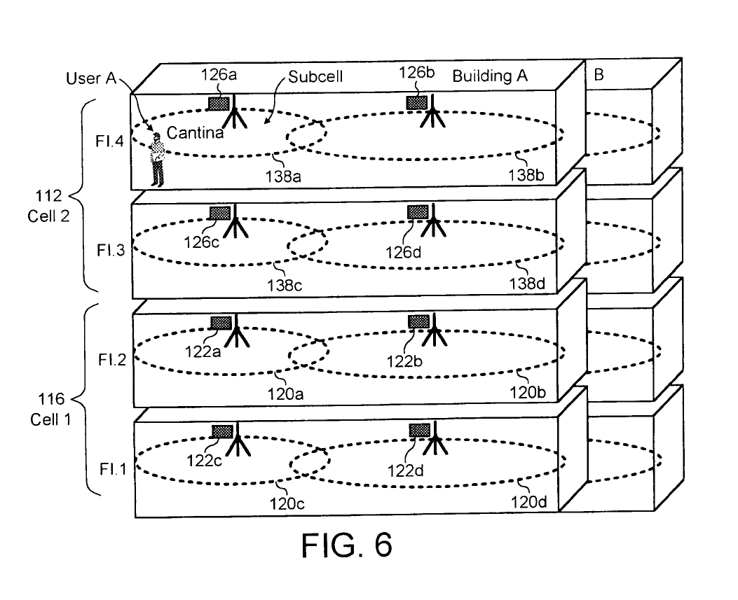

From the above description of FIG. 5, it will be apparent that the cells 112, 114 and 116 are made up of respective sub-cells, and comprise an indoor radio system. A microcell 110 comprises an outdoor radio system associated with the same BTS. The practical implementation of an indoor radio system is explained further with relation to FIG. 6.

As illustrated in FIG. 6, the sub-cells of the indoor radio system are distributed across different floors of different buildings. There is shown in FIG. 6 two buildings: building A and building B. Each building has four floors: floors 1-4. The example is described herein with reference to building A. As shown in FIG. 6, the sub-cells of cell 116 are distributed across the first two floors of building A, and the sub-cells of cell 112 are distributed across the third and fourth floors of building A. Thus sub-cells 120c and 120d provide radio coverage on the first floor of building A, sub-cells 120a and 120b provide radio coverage on the second floor of building A, sub-cells 138c and 138d provide radio coverage on the third floor of building A, sub-cells 138a and 138b provide radio coverage on the fourth floor of building A. The remote head unit associated with each cell is similarly located on the respective floor of the building, a physical location which establishes a radio coverage area of the respective sub-cell.

In accordance with the present invention, a location of any particular user can be identified. For example, consider user A who is located, as can be seen from FIG. 6, on the fourth floor of building A within the radio coverage area of sub-cell 138a, which covers the ‘canteen’ area.

Based on the signals received at the base transceiver station, a system is first able to establish that the user is located within cell 112, i.e. on the third or fourth floor of building A. Based on detection of which remote head unit signal received from the mobile station of user A is identified at, the system is able to identify that the user is located within the radio coverage area of sub-cell 138a, i.e. on the fourth floor of building A, within the locality of the canteen.

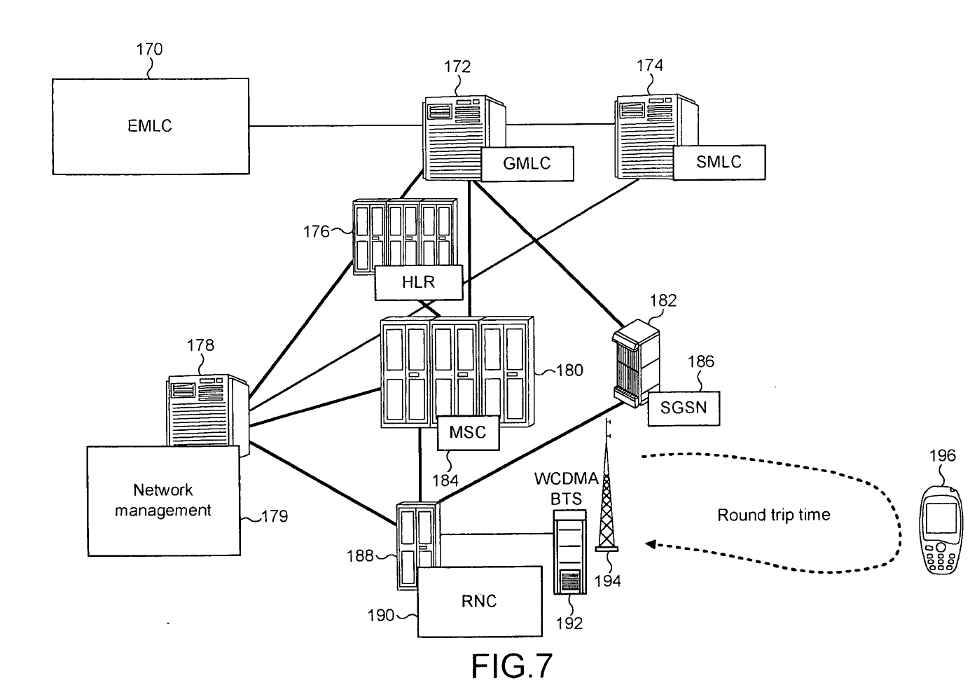

FIG. 7 illustrates the main components in a mobile communication system for performing round trip time (RTT) mobile location positioning estimation in a known manner. A mobile station 196 receives signals from a network, and transmits signals to the network. A WCDMA BTS 192 is associated with an antenna 194 which is in communication with the mobile station 196. The BTS 192 is connected to network element 188 including a radio network controller 190. The network element 188 is connected to network elements 178 and 182, which respectively include network management functionality 179 and a serving GPRS support node 186. Network element 188 also connects to a network element 180 which includes a mobile switching center 184 and a home location register 176. The elements 178, 180 and 182 are further connected to a gateway mobile location center 172, which in turn is connected to an enabling mobile location center 170 and a serving mobile location center 174.

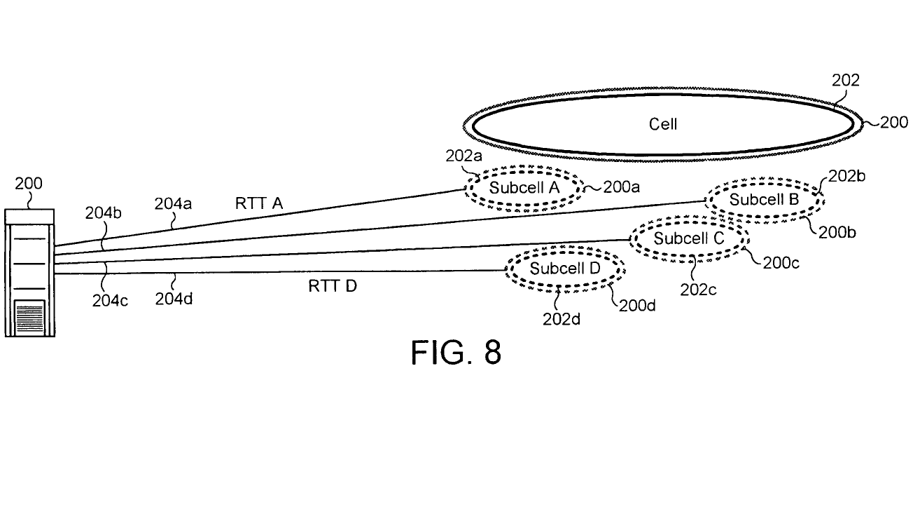

The calculation of the round trip time for the mobile station in accordance with the present invention is determined as represented in FIG. 8. As discussed hereinabove with relation to FIG. 6, the present invention facilitates a technique for identifying a sub-cell within which the signal from a mobile station has been received. In the example of FIG. 8, it is assumed that a signal is received in all sub-cells 202a-202b of cell 202. For each of the received signals, a round trip time in accordance with conventional techniques is determined and returned to the BTS 200. A respective round trip time RTTa-RTTd is returned on each of the links 204a-204d. In addition, multiple round trip times may be determined by a particular cell. For example in FIG. 8, each sub-cell is associated with two radio frequencies. The signal is received at a remote head unit for such sub-cell on both radio frequencies, and a round trip time for each such frequency of the sub-cell may be calculated.

The present invention has been described hereinabove with reference to a particular non-limiting example. A person skilled in the art will realize the applicability of the invention being broader than the specific examples given herein.

Modifications and adaptations to the invention will be apparent to one skilled in the art. The scope of protection afforded by the present invention is defined by the appended claims.

1. In a communication system comprising a receiver and a plurality of sub-receivers, wherein signals received at each sub-receiver are forwarded to the receiver, a method for determining at which one of the plurality of sub-receivers a signal received at the receiver is received from, comprising: allocating a time delay to each sub-receiver; delaying a signal received at each sub-receiver by the corresponding time delay; and determining the presence of a received signal in a time window associated with each time delay, wherein a signal received in a time window associated with a particular time delay is determined to have been received by the corresponding sub-receiver.

2. A method according to claim 1, wherein the communication system is a cellular communication system, each sub-receiver being associated with a sub-cell of a cell associated with the receiver.

3. A method according to claim 2, wherein the identification of the sub-receiver at which a signal is received identifies the sub-cell area within which the signal is transmitted from.

4. A method according to claim 3, further comprising identifying the location within the sub-cell from which the signal is transmitted from.

5. A method according to claim 2, wherein the communication system is an indoor radio system.

6. A method according to claim 1, wherein the signal is received from a mobile station.

7. A method according to claim 1, wherein the receiver is part of a base transceiver station.

8. A receiver for receiving signals from a plurality of sub-receivers, including: means for delaying a signal from each respective sub-receiver by a respective pre-determined time delay; and means for determining the presence of a received signal in a time window associated with each respective time delay, wherein a signal received in a time window associated with a particular time delay is determined to have been received by the corresponding sub-receiver.

9. A receiver according to claim 8 wherein the means for delaying a signal from each respective sub-receiver comprises a delay element having the predetermined delay time.

10. A receiver according to claim 9 wherein the delay element includes a filter.

11. A receiver according to claim 10 wherein the filter is a surface acoustic wave filter.

12. A receiver according to claim 9, wherein the delay element includes an optical transmission line.

13. A receiver according to claim 8, wherein the means for determining the presence of a received signal includes a rake filter.

14. A receiver according to claim 8, wherein the receiver is associated with a base transceiver station defining a cell of the communication system, each sub-receiver defining a sub-cell of the cell.

15. A receiver according to claim 14, wherein a signal determined to be received at a particular sub-receiver identifies the source of the signal in the respective sub-cell.

16. A receiver according to claim 15, further comprising means for identifying the location of the source of the signal in the sub-cell.
